(19) United States
(12) Patent Application Publication
(10) Pub. No.: US 2025/0170435 A1
(43) Pub. Date: May 29, 2025

(54) FALL PROTECTION SYSTEMS AND METHODS

(71) Applicant: The Boeing Company, Arlington, VA (US)

(72) Inventors: Alexandru Gheorghe Badger, Stanwood, WA (US); Gerald Oren Pollard, Snohomish, WA (US)

(73) Assignee: The Boeing Company, Arlington, VA (US)

(21) Appl. No.: 18/521,365

(22) Filed: Nov. 28, 2023

(51) Int. Cl. A62B 35/00; F16D 63/00; G05B 15/02

(52) U.S. Cl. CPC A62B 35/0093; A62B 35/0025; F16D 63/006; G05B 15/02; A62B 35/0018

(57) ABSTRACT

A fall protection system and a method includes a housing having a cavity and engagement features, and a rotating device disposed within the cavity that rotates about an axis of the housing. A resilient assembly is coupled with the rotating device and includes a spring device and an extension member that can move between a first position and a second position. A locking component is coupled with the rotating device and the resilient assembly and moves between an unlocked state and one of a first locked state or a second locked state. The locking component moves to the first locked state based on a rotational speed of the rotating device, or to the second locked state based on the extension member moving between the first and second positions responsive to the resilient assembly receiving a control signal.

### FIELD OF THE DISCLOSURE

Examples of the present disclosure generally relate to personal fall protection systems and methods.

### BACKGROUND OF THE DISCLOSURE

Regulations require all people using a lift system (e.g., aerial work platforms, bucket lifts, boom lifts, paint stackers, scissor lifts, etc.) to be wearing a safety protection harness that is to be connected to the lift system so that the occupant may not fall from the lift. Occupants may connect their harness to the lift using either a fixed-length lanyard or a self-retracting lanyard (SRL). Single-lead fixed-length lanyards are preferred when occupants do not need to leave the safety of the lift to do work. Dual-lead fixed-length lanyards enable occupants to keep one lead attached to the lift while connecting the second lead to an external anchor. SRL systems are used when occupants must leave the lift to do work and external anchors are not available to connect to.

If an occupant using a fixed-length lanyard falls from a lift, their fall distance is limited by the length of the lanyard connecting their safety harness to the lift. Whereas if an occupant using an SRL falls from a lift, their fall distance is limited by the length of the lanyard extending from the SRL prior to the fall plus the additional length of lanyard extended from the SRL prior to SRL lockup. The Occupational Safety and Health Administration (OSHA) requires the maximum free fall to be no more than six feet.

One or more locking components within the SRL move between an unlocked state and a locked state based on mechanical forces acting on the system. For example, when an occupant falls, the lanyard is pulled out of the SRL at a rate proportional to the weight of the occupant. The centrifugal forces acting on the locking pawls in the SRL cause the locking pawls to overcome spring tension and rotate outwards to the locked position. When the locking pawls engage ratchet latches of the SRL, the rotation of the SRL is stopped and no additional lanyard can be extended. The total length of the fall is equal to the sum of length of the lanyard that was extended prior to the fall and the additional length of the lanyard extended before the SRL detected the fall and locked up.

The mechanic design of existing SRLs require a person (or object) to fall for a length of time and/or distance before the centrifugal forces acting on the locking components can move the locking components to the locked state. The length of time and/or distance that the person falls before the locking components move to the locked state and stop travel of the retractable safety strap may cause significant rebound and shock forces to act on the person once travel of the retractable safety strap is stopped. For example, the SRL may stop the person (or object) from falling, but due to the speed developed during the fall, the rebound forces acting on the occupant may cause injury.

### SUMMARY OF THE DISCLOSURE

A need exists for a fall protection system and method that is a dual safety system in which the dual safety system may move to a locked position based on either of mechanical forces acting on the fall protection system or electrical inputs received by the fall protection system, whichever is the first to occur. For example, the fall protection system and method described herein may move from the unlocked state to a locked state in an amount of time that is faster (e.g., a shorter amount of time) than an amount of time it may take for a single safety system (e.g., a fall safety system that relies only on mechanical forces acting on the fall safety system to move from the unlocked state to the locked state and is not electrically controlled).

By using algorithms personalized for each user and/or object, emanate falls can be detected and stopped before they occur while enabling users the maximum amount of freedom of movement without nuisance lockups.

With those needs in mind, certain examples of the present disclosure provide a fall protection system that includes a housing with a cavity and engagement features extending into surfaces of the housing, and a rotating device that is disposed within the cavity of the housing and rotates about an axis of the housing. A resilient assembly is coupled with the rotating device and includes a spring device and an extension member that is coupled with the spring device. The extension member can move between a first position (e.g., a retracted position) and a second position (e.g., an extended position).

The fall protection system may also include a locking component that is coupled with the rotating device and the resilient assembly. The locking component moves between an unlocked state and a first locked state or between the unlocked state and a second locked state. The locking member is configured to engage with at least one of the engagement features of the housing while the locking component is in the first locked state or the second locked state. The locking component moves from the unlocked state to the first locked state or the second locked state based on one of the following: a rotational speed of the rotating device, or the extension member moving between the first position and the second position responsive to the resilient assembly receiving one or more control signals.

In one example, the locking component moves from the unlocked state to the first or second locked states responsive to a first to occur between the rotational speed of the rotating device exceeding a designated threshold or the resilient assembly receiving the one or more control signals. For example, if the rotational speed exceeds the designated threshold before the resilient assembly receives the control signals, the locking component may move from the unlocked state to the first locked state based on mechanical forces acting on the locking component. Alternatively, if the resilient assembly receives the control signals before the rotational speed exceeds the designated threshold, the locking component may move from the unlocked state to the second locked state based on electrical inputs received by the resilient assembly.

In another example, the locking component may move from the first or second locked states to the unlocked state responsive to one of the rotational speed of the rotating device being less than a designated threshold or the extension component moving from the second position to the first position. Alternatively, the locking component may return to the unlocked state from the first or second locked states responsive to the fall protection system receiving another input, a change in one or more components of the fall protection system, or the like.

In one example, the locking component may prohibit rotation of the rotating device within the housing while the locking component is in the first or second locked states. In another example, the locking component may be in contact with one or more surfaces of the engagement feature of the housing while the locking component is in the first or second locked states. The engagement feature and the locking component may be shaped, sized, oriented, or the like, to correspond to each other such that the locking component may engage with the engagement features and prohibit rotation of the rotating device while the locking component is in the locked state.

In another example, the fall protection system may include a retractable lanyard that extends between the rotating device and a harness system. The harness system may be coupled with an object (e.g., an operator or other object) and may provide fall protection to the object while the object moves between plural different elevated positions. For example, the housing may include an anchoring component configured to connect the housing to a portion of a lift system that moves between plural different elevated positions. The locking component in the first or second locked states controls a distance of travel of the retractable lanyard. In one example, the resilient assembly may receive the control signal from one or more processors of the harness system responsive to an amount of movement of the object operably coupled with the harness system exceeding a designated threshold. Optionally, the resilient assembly may be electrically coupled with the processors of the harness system via one or more of a wired or wireless connection.

In another example, the resilient assembly may receive a first control signal from the one or more processors of the harness system to move the extension member from the first position to the second position. Alternatively, the resilient assembly may receive a second control signal from the one or more processors of the harness system to move the extension member from the second position to the first position.

Certain examples of the present disclosure provide a method that includes moving a locking component of a fall protection system between an unlocked state and one of a first locked state or a second locked state. The locking component is moved from the unlocked state to the first locked state based on a rotational speed of a rotating device disposed within a housing of the fall protection system. The housing includes plural surfaces that define a cavity in which the rotating device is disposed and configured to rotate. The housing also includes one or more engagement features. The fall protection system also includes a resilient assembly that is coupled with the rotating device. The locking component is coupled with the rotating device and the resilient assembly.

Alternatively, the locking component is moved from the unlocked state to the second locked state based on an extension member of the resilient assembly moving between a first position and a second position responsive to the resilient assembly receiving one or more control signals. The extension member moving between the first and second positions moves the locking component between the unlocked state and the second locked state.

Certain examples of the present disclosure provide a fall protection system that includes a housing having surfaces defining a cavity and one or more engagement features, and a rotating device disposed within the housing that rotates about an axis of the housing. A solenoid assembly is coupled with the rotating device and includes a spring device and an extension member coupled with the spring device. The extension member moves between a retracted position and an extended position responsive to a change in an electric current within the solenoid assembly.

A locking component is coupled with the rotating device and the solenoid assembly. The locking component moves between an unlocked state and a first locked state or between the unlocked state and a second locked state. As one example, the locking component moves from the unlocked state to the first locked state responsive to a rotational speed of the rotating device exceeding a designated threshold. Alternatively, the locking component moves from the unlocked state to the second locked state responsive to the extension member moving from the retracted position to the extended position.

### BRIEF DESCRIPTION OF THE DRAWINGS

FIG. 1 illustrates a schematic of a safety harness system operably coupled with a fall protection system, according to an example of the present disclosure.

FIG. 2 illustrates a front view of a fall protection system, according to an example of the present disclosure.

FIG. 3 illustrates a partial cross-sectional view of a fall protection system in an unlocked state, according to an example of the present disclosure.

FIG. 4 illustrates a partial cross-sectional view of the fall protection system shown in FIG. 3 in a first locked state, according to an example of the present disclosure.

FIG. 5 illustrates a partial cross-sectional view of the fall protection system shown in FIG. 3 in a second locked state, according to an example of the present disclosure.

FIG. 6 illustrates a flow chart of a method, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

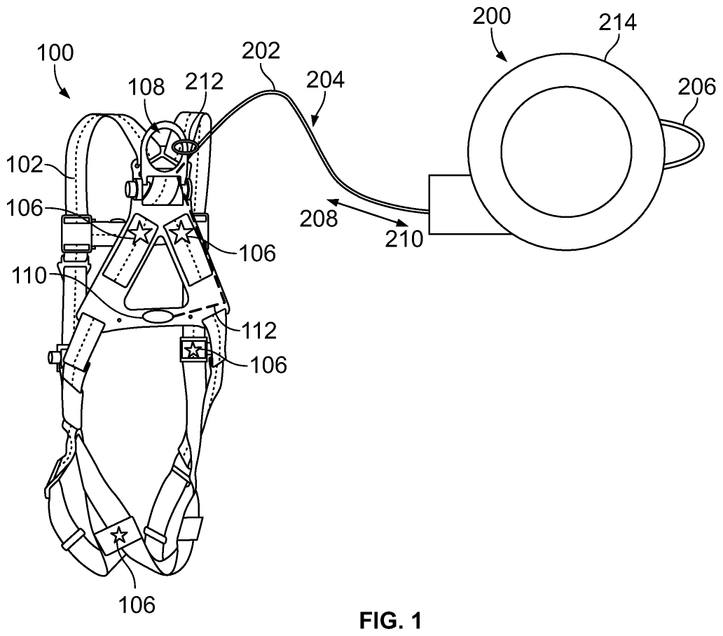

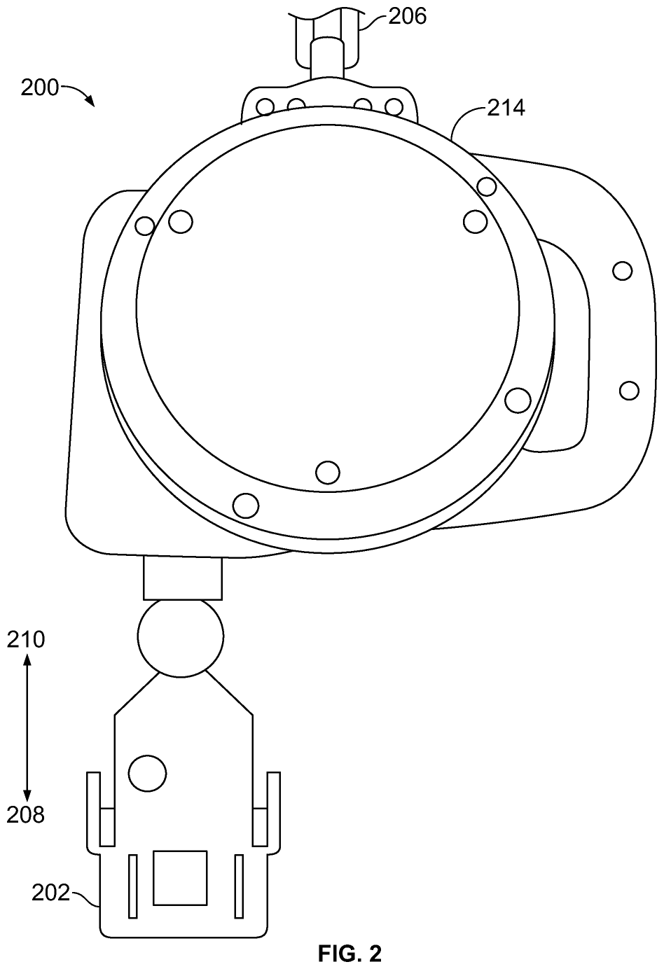

FIG. 1 illustrates a schematic of a safety harness system 100 operably coupled with a fall protection system 200, in accordance with one example. FIG. 2 illustrates a front view of the fall protection system 200, in accordance with one example. The safety harness system 100 includes plural straps 102 that may be operably coupled with and extend around an object (not shown). In one example, the object may be a person, or alternatively in another example the object may be a piece of equipment, machinery, or any alternative structure or component.

In one example, the object may be a person using the safety harness system 100. As one example, the person may be disposed within a lift system (not shown) that may move the person between different elevations so that the person may perform maintenance and/or inspection on a structure, such as a building, an aircraft system, utility equipment, or the like. The lift system may be an elevated stationary platform on which the person may be disposed, such as to perform work at an elevated position. In one or more examples, the lift system may be a mobile elevating work platform or a stationary elevating work platform such as, but not limited to, an aerial work platform, a cherry picket, a bucket lift, a boom lift, a paint stacker, a scissor lift, alternative scaffold system, or the like. As another example, the object may be a component using the safety harness system 100. The component may be moved to different positions, such as via a lift system (not shown), to move the component to different locations (e.g., different elevations, different lateral positions, or the like). The safety harness system 100 may be coupled with a person and/or structure while the person and/or object is positioned and/or moved to one or more elevated positions (e.g., above a ground level).

The safety harness system 100 includes one or more sensors 106 that are operably coupled with the one or more straps 102. The sensors may include position sensors, accelerometers, gyroscopes, magnetometers, inertial measurement sensors, cameras and/or video motion sensors, proximity sensors, vibration sensors, ultrasonic transducers, or the like. In one or more examples, one or more of the sensors may be operably coupled with and/or embedded within the one or more straps 102 of the safety harness system 100 at different locations of the straps 102. In one example, one or more of the sensors 106 may be retroactively added to and/or coupled with one of the straps 102 of the safety harness system 100. In another example, one or more of the sensors 106 may be embedded within the straps 102 of the safety harness system 100 during the manufacture and/or fabrication of the safety harness system 100.

The safety harness system 100 also includes a controller 110 that is operably coupled with the straps 102. In one or more examples, the controller may be operably coupled with the sensors 106 such that the controller may receive data from the one or more sensors 106.

In one example, the controller 110 may be retroactively coupled with the straps (e.g., after the safety harness system 100 has been fabricated, manufactured, and/or used in operation), and/or the controller 110 may be coupled with the straps 102 while the safety harness system 100 is being fabricated and/or manufactured. The placement of the controller 110 may be based on a general center of mass of the object while the object is coupled with the straps 102, based on the type, shape, and/or size of the object, based on the placements and/or types of the different sensors 106, or any combination therein.

The controller 110 includes one or more processors (not shown), such as one or more microprocessors, field programmable gate arrays, integrated circuits, and/or the like. In one example, the controller may include a single processor or multiple processors. All operations can be performed by each processor, or each processor may perform at least one different operation than one or more (or all) other processors.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the controller 110 may be or include one or more processors that are configured to control operation, as described herein.

The controller 110 is configured to execute a set of instructions that are stored in one or more other data storage units or elements in order to process data. The data storage units may also store data or other information as desired or needed. The data storage units may be in the form of an information source or a physical memory element within a processing machine.

The set of instructions may include various commands that instruct the controller 110 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the controller 110. It is to be understood that the processing or controllers may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the controller 110 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

The safety harness system is operably coupled with a fall protection system 200 via a retractable lanyard 202 that extends between an exterior housing 214 of the fall protection system and a connector 108 of the safety harness system.

In the illustrated example, the retractable lanyard includes a coupling feature 212 that connects the lanyard to the connector 108, but in alternative examples the retractable lanyard may be coupled with the safety harness system 100 via an alternative coupling method. The retractable lanyard is arranged to move in a first direction 208 out of and away from the exterior housing 214 or in a second direction 210 into the exterior housing 214. In one or more examples, the fall protection system 200 may be referred to as a self-retracting lifeline (SRL). For example, the self-retracting lifeline may be a safety lifeline for the object operably coupled with the safety harness system 100 and to control a distance that the object may be allowed to fall if the object becomes separated from the lift system (not shown) to which the self-retracting lifeline is coupled.

In one example, the safety harness system 100 includes one or more wires 112 that extend between the controller 110 and one or more cables 204 disposed within or operably coupled with the retractable lanyard 202. For example, the wires 112 electrically connected with the cables 204 provide an electrical connection between the controller 110 and one or more components or systems of the fall protection system 200.

In one example, the exterior housing 214 of the fall protection system 200 includes an anchoring component 206 that allows the fall protection system 200 to be anchored to a stabilizing component (e.g., a lift system, a lift basket, an alternative anchoring structure, or the like). For example, the anchoring component 206 may be coupled to a portion of a lift system that moves between plural different elevated positions.

In one or more examples, a locking system (not shown) may be disposed between the safety harness system 100 and the fall protection system 200. For example, the safety harness system 100 may be operably coupled with (e.g., mechanically and electrically) with a locking system, and the fall protection system 200 may be operably coupled with (e.g., mechanically and electrically) with the locking system such that the locking system operably couples the safety harness system 100 with the fall protection system 200. For example, data and/or electrical signals may be passed through the locking system between the safety harness system 100 and the fall protection system 200 to allow the safety harness system 100 to communicate with the fall protection system 200.

In one example, power may be passed through the locking system between the safety harness system 100 and the fall protection system 200. For example, the fall protection system 200 may be electrically coupled with a power device of a lift system (not shown) and may pass electric current through the locking system to the safety harness system 100 to provide power to the controller 110, the sensors 106, and/or one or more other systems of the safety harness system 100.

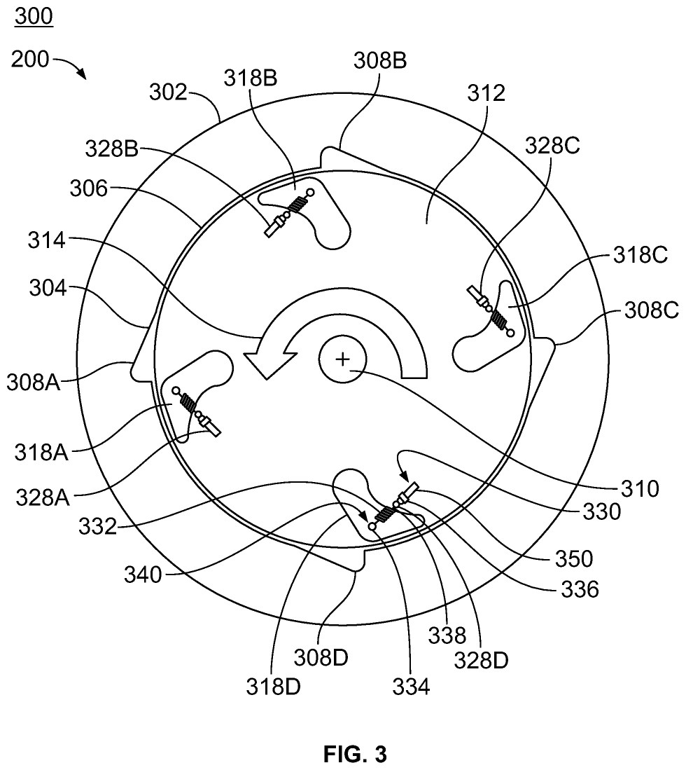

FIG. 3 illustrates a partial cross-sectional view of the fall protection system 200 in an unlocked state 300, in accordance with one example. In the illustrated example, the fall protection system 200 includes a housing 302 that includes one or more interior surfaces 304 that define a cavity 306. The housing 302 extends about an axis 310. The housing 302 includes one or more engagement features 308A-D. In the illustrated example, the engagement features 308A-D are recesses, divots, concave features, etc., that extend into the surfaces 304 of the housing that define the cavity 306 and away from the axis 310. In one example, the engagement features 308A-D may be referred to as ratchet latches. In alternative examples, the engagement features may have alternative shapes, sizes, positions, or the like.

The fall protection system 200 includes a rotating device 312 that is disposed within the cavity 306 of the housing 302. In the illustrated example, the rotating device has a shape and size that is substantially the same as the shape and size of the cavity 306. The retractable lanyard 202 (shown in FIGS. 1 and 2) is operably coupled with the rotating device 312 such that rotation of the rotating device 312 directs the lanyard in the first and second directions 208, 210 out of and into the fall protection system 200, respectively. For example, the rotating device 312 rotates in a first direction of rotation 314 responsive to the lanyard moving in the first direction 208 out of and away from the fall protection system 200.

The fall protection system 200 includes one or more locking components 318A-D that are operably coupled with the rotating device 312. The locking components 318A-D are shaped and sized to correspond to the shape and size of the engagement features 308A-D of the housing 302. The locking components 318A-D are operably coupled with the rotating device 312 such that the locking components 318A-D rotate about the axis 310 based on the rotation of the rotating device 312, and each of the locking components 318A-D are free to rotate about a corresponding locking axis (not shown) of each locking component 318A-D. For example, if the rotational speed of the rotating device 312 exceeds a threshold, each of the locking components 318A-D may rotate about a corresponding locking axis based on the inertia acting on the locking components 318A-D. In one example, the locking components may be referred to as locking pawls that may rotate outward to engage the engagement features.

Each of the locking components 318A-D is operably coupled with a corresponding resilient assembly 328A-D. For example, the resilient assembly 638A is operably coupled with the locking component 318A, the resilient assembly 328B is operably coupled with the locking component 318B, the resilient assembly 328C is operably coupled with the locking component 318C, and the resilient assembly 328D is operably coupled with the locking component 318D.

Each resilient assembly 328A-D includes an extension member 330 and a spring device 332 that is coupled with the corresponding extension member 330. Each spring device 332 extends between a first end 338 that is coupled with a second end 336 of the corresponding extension member 330, and a second end 340 that is coupled with the corresponding locking component 318A-D. The extension members 330 may also be referred to as extension pins and may be operably coupled with one or more solenoid devices (not shown). In one or more examples, the resilient assemblies may be referred to as solenoid assemblies that includes at least a solenoid device having an extension member (e.g., a pin), and the spring device that is operably coupled with the extension member and the locked component.

The cross-sectional view of the fall protection system 200 shown in FIG. 3 is merely exemplary, and non-limiting. For example, the illustrated embodiment of the fall protection system 200 includes four engagement features 308A-D, four locking components 318A-D, and four resilient assemblies 328A-D. For example, in alternative embodiments, the fall protection system 200 may include less than four or more than four of one or more of the engagement features, the locking components, and/or the resilient assemblies, the locking components and/or the engagement features may have any alternative shape, size, style, positioning, or the like, about the axis, or any combination therein.

In the illustrated example shown in FIG. 3, the fall protection system 200 is in the unlocked state 300. For example, while the fall protection system 200 is in the unlocked state 300, the rotating device 312 is free to rotate about the axis 310 of the housing in the first direction of rotation 314 thereby allowing the retractable lanyard to move in the first direction 208 out of the housing 302 of the fall protection system 200. The state of the fall protection system 200 may change from the unlocked state to a first locked state or from the unlocked state 300 to a second locked state responsive to one or more mechanical or electrical inputs. For example, the retractable lanyard 202 may be prohibited from moving in the first direction 208 out of the housing 302 responsive to the state of the fall protection system 200 changing from the unlocked state to either the first or second locked states. The fall protection system 200 in the first and second locked states controls a distance of travel of the retractable lanyard 202 in the first direction 208. Additionally, the locking components prohibit rotation of the rotating device 312 within the housing 302 while the fall protection system 200 is in either the first locked state or the second locked state.

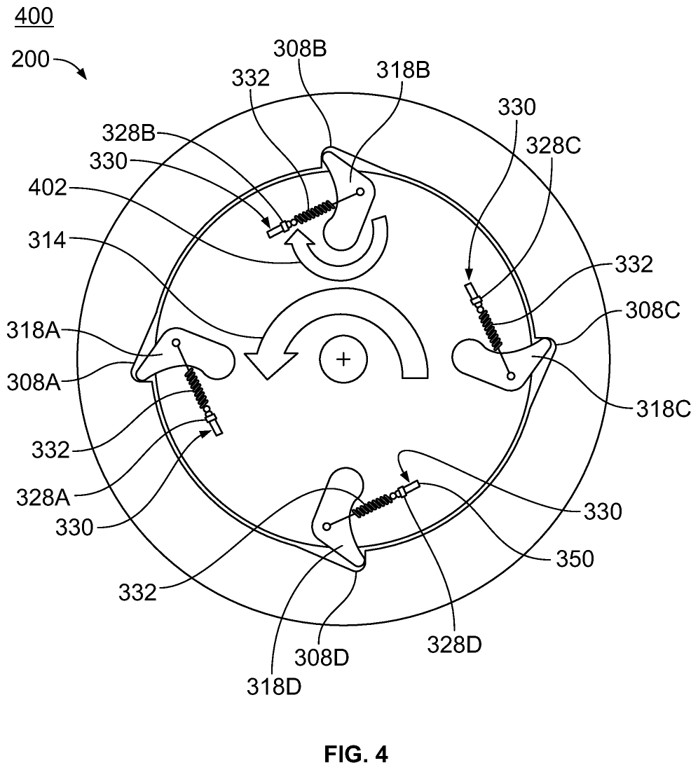

As one example, FIG. 4 illustrates a partial cross-sectional view of the fall protection system 200, in accordance with another example. In the illustrated example shown in FIG. 4, the fall protection system 200 is in a first locked state 400. The fall protection system 200 may move from the unlocked state 300 to the first locked state 400 based on one or more mechanical inputs.

For example, while the locking components 318A-D rotate with the rotating of the rotating device 312, the spring devices 332 (e.g., which may be compression springs) may attempt to pull the corresponding locking component 318A-D back to a compressed state. However, a speed of rotation of the rotating device 312 in the first direction of rotation 314 may reach a limit. In one or more examples, the corresponding spring devices 332 may extend due to the rotational forces applied to the locking components 318A-D. For example, a rotational energy acting on one or more of the locking components 318A-D may cause the locking components 318A-D to overcome tension from the corresponding spring devices 332 and rotate outward in a second direction of rotation 402 and engage one or more of the engagement features 308A-D of the housing 302 responsive to the speed of rotation of the rotating device 312 reaching a rotational limit.

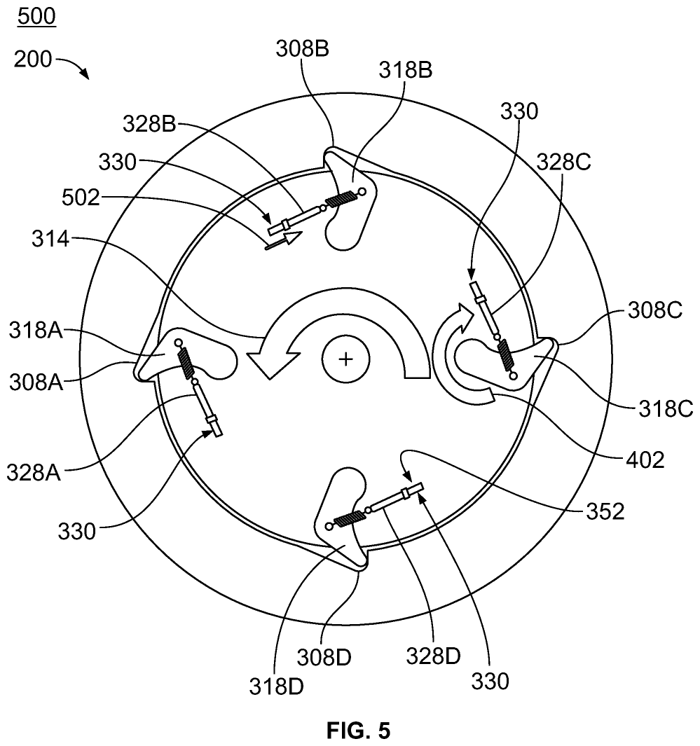

As another example, FIG. 5 illustrates a partial cross-sectional view of the fall protection system 200 in a second locked state 500. The fall protection system 200 may move from the unlocked state 300 to the second locked state 500 based on one or more electrical inputs.

For example, the fall protection system 200 may move to the second locked state 500 responsive to the controller 110 of the safety harness system 100 transmitting a control signal to the fall protection system 200. As one example, the controller 110 of the safety harness system 100 may be operably coupled with the another component of the fall protection system 200 (e.g., one or more solenoid devices, not shown) via one or more wired and/or wireless connections to control operation of the solenoid devices. The controller 110 may determine that the speed of movement of the object exceeds a movement threshold based on data received by the controller 110 from the one or more sensors 106 and may transmit a control signal to the fall protection system 200 responsive to determining that the speed of movement of the object exceeds the movement threshold. In one or more examples, the control signal may be an electrical signal that may change a current that is applied to and/or received by the one or more solenoid devices.

The change in current that is applied to and/or received by the solenoid devices may cause one or more of the extension members 330 to move between first positions 350 (shown in FIGS. 3 and 4) and second positions 352 (shown in FIG. 5) in a third direction of movement 502. For example, the extension members 330 in the first positions 350 may be in retracted states, and the extension members 330 in the second positions 352 may be in extended states. Moving the extension members 330 from the first positions 350 to the second positions 352 causes the corresponding locking component 638A-D to rotate in the second direction of rotation 402 and engage one of the engagement features 308A-D of the housing. Optionally, the extension members may be operably coupled with an electrical device and/or system other than a solenoid device. For example, the extension members may be operably coupled with another electrical device and/or system that may control movement of the extension members between retracted and extended states responsive to receiving the control signal from the controller 110 of the safety harness system 100.

The fall protection system 200 may change from the unlocked state 300 to the first or second locked states 400, 500 based on to one or more mechanical or electrical inputs. For example, the fall protection system 200 is a dual safety system that may move to a locked position based on either of the mechanical or electrical inputs. The dual safety system may move from the unlocked state to the second locked state at a speed that may be faster than a fall protection system that is a single safety system and can only move from the unlocked state to the first locked state (and not the second locked state) based on just mechanical inputs. For example, the controller 110 may determine that the speed of movement of the object exceeds the movement threshold before the rotational speed of the rotating device 312 reaches a speed of rotation that causes the locking components 318A-D to rotate to engage with the engagement features 308A-D of the housing. For example, the control signal from the controller 110 may cause the extension members 330 to move to the second positions 352 (e.g., extended states) before the speed of rotation of the rotating device 312 causes the locking components 318A-D to rotate.

For example, the processors of the controller 110 may detect an imminent fall of the object, and may transmit the control signal to the fall protection system to lock the fall protection system before the object falls. The processors may determine that the object is about to fall, that a fall of the object is about to occur (e.g., within about 10 milliseconds, within about 100 milliseconds, within about 1 second, or the like) before the fall occurs. Changing the locking state of the fall protection system from the unlocked state 300 to the second locked state 500 with the electrical signal allows the safety harness system to lock the fall protection system 200 at a speed that is faster than the fall protection system 200 is able to change from the unlocked state 300 to the first locked state 400 as a result of the mechanical forces acting on the locking components, and controls an amount of shock the object may experience. For example, the controller may detect an emanate fall of the object and may transmit the signal before the fall occurs to lock the fall protection system prior to the fall protection system moving to the locked state due to the mechanical (e.g., rotational) forces acting on the locking components 318A-D.

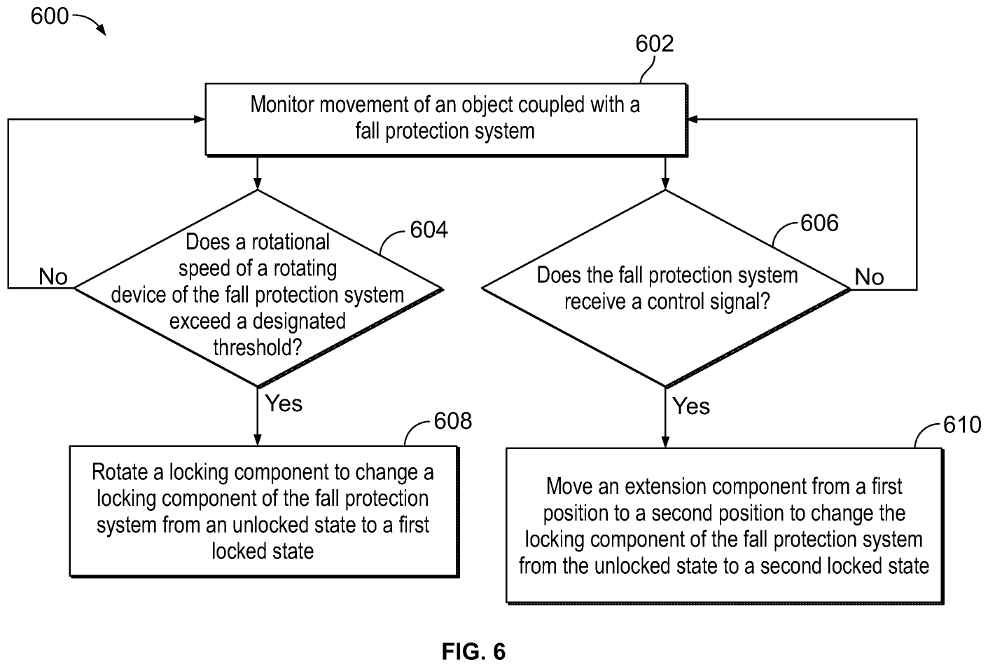

FIG. 6 illustrates a flow chart 600 of a method, such as for controlling a locking state of a fall protection system 200, in accordance with one example. The method includes monitoring movement 602 of an object that is coupled with a fall protection system, such as the fall protection system 200 illustrated in FIG. 1. The fall protection system may include a retractable lanyard that extends between the fall protection system and a safety harness system. The fall protection system may be coupled with a lift system, and the safety harness system may be coupled with an object (e.g., an operator or other object) to provide fall protection to the object that is coupled with the safety harness system.

The fall protection system may be in an unlocked state while the object that is coupled with the fall protection system via the safety harness system is moved to one or more elevated positions. The state of the fall protection system may change from the unlocked position to a first locked position (e.g., illustrated in FIG. 4) or a second locked position (e.g., illustrated in FIG. 5) responsive to whichever is the first to occur: one or more mechanical forces acting on a locking component of the fall protection system; or one or more electrical inputs received by the fall protection system,

For example, if a rotational speed 604 of a rotating device of the fall protection system exceeds a designated threshold, the rotating forces generated by the rotating device may generate centrifugal forces that may be applied to the locking components, thereby causing the locking components to rotate 608 to move from the unlocked state to a first locked state.

Alternatively, if the fall protection system receives a control signal 606, such as from a controller of the safety harness system, an extension component of the fall protection system may move 610 from a first position (e.g., a retracted position) to a second position (e.g., an extended position), thereby causing the locking component operably coupled with the extension component to rotate to move from the unlocked state to a second locked state.

In one example, the rotational speed of the rotating device may exceed the designated threshold before the fall protection system 200 receives the control signal from the safety harness system 100. As a result, the fall protection system 200 may move from the unlocked state to the first unlocked state. In another example, the fall protection system 200 may receive the control signal from the safety harness system 100 before the rotational speed of the rotating device exceeds the designated threshold. As a result, the fall protection system 200 may move from the unlocked state to the second unlocked state. The fall protection system 200 may move from the unlocked state to the first locked state, or from the unlocked state to the second locked state, based on which occurs first between the rotational speed of the rotating device exceeding the designated threshold or the fall protection system receiving the control signal.

In one example, the fall protection system may change from the first locked state or the second locked state to the unlocked state based on one or more inputs. As one example, the locking component(s) may move from one or both of the first or second locked states to the unlocked state responsive to the rotational speed of the rotating device being less than the designated threshold (e.g., the speed of rotation of the rotating device slows down and/or stops). As another example, the locking component(s) may move from one or both of the first or second locked states to the unlocked state responsive to the fall protection system receiving a second control signal causing the extension component to move from the second position to the first position. As another example, the locking component(s) may move from one or both of the first or second locked states to the unlocked state responsive to the retractable lanyard moving in the first direction 208 until the retractable lanyard can no longer move in the first direction 208 (e.g., substantially the full length of the retractable lanyard has been pulled out of the fall protection system). In an alternative example, the locking component(s) may move from one or both of the first or second locked states to the unlocked state based on an alternative input (e.g., mechanical and/or electrical) received by the fall protection system.

Referring to FIGS. 1-6, examples of the subject disclosure provide systems and methods that allow large amounts of data to be quickly and efficiently analyzed by a computing device. For example, the controller 110 can analyze various aspects of the safety harness system 100, the object coupled with the straps 102, the fall protection system 200, the lift system (not shown) to which the safety harness system 100 is coupled, and the like. As such, large amounts of data, which may not be discernable by human beings, are being tracked and analyzed. The vast amounts of data are efficiently organized and/or analyzed by the controller 110, as described herein. The controller 110 analyzes the data in a relatively short time in order to quickly and efficiently determine the state and/or position of the object. A human being would be incapable of efficiently analyzing such vast amounts of data in such a short time. As such, examples of the present disclosure provide increased and efficient functionality, and vastly superior performance in relation to a human being analyzing the vast amounts of data.

In at least one example, all or part of the systems and methods described herein may be or otherwise include an artificial intelligence (AI) or machine-learning system that can automatically perform the operations of the methods also described herein. For example, the controller 110 can be an artificial intelligence or machine learning system. These types of systems may be trained from outside information and/or self-trained to repeatedly improve the accuracy with how data is analyzed. Over time, these systems can improve by determining such information with increasing accuracy and speed, thereby significantly reducing the likelihood of any potential errors. For example, the AI or machine-learning systems can learn and determine the performance capabilities of different objects that may be coupled with the safety harness system 100, anticipated or expected movements or motions of the objects, and the like, and automatically determine when an amount of movement or motion of the object exceeds an allowable movement or motion threshold. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), and/or the like. The systems may be trained and re-trained using feedback from one or more prior analyses of the data, ensemble data, and/or other such data. Based on this feedback, the systems may be trained by adjusting one or more parameters, weights, rules, criteria, or the like, used in the analysis of the same. This process can be performed using the data and ensemble data instead of training data, and may be repeated many times to repeatedly improve the determination of an allowable amount of movement or motion of the object coupled with the safety harness system 100. The training minimizes conflicts and interference by performing an iterative training algorithm, in which the systems are retrained with an updated set of data (for example, data received before, during, and/or after each use of the safety harness system 100) and based on the feedback examined prior to the most recent training of the systems. This provides a robust analysis model that can better determine situational information in a cost effective and efficient manner.

Further, the disclosure comprises examples according to the following clauses:

Clause 1: a fall protection system, comprising:
a housing comprising one or more surfaces defining a cavity, the housing including one or more engagement features extending into the one or more surfaces;
a rotating device configured to be disposed within the cavity of the housing and configured to rotate about an axis of the housing;
a resilient assembly configured to be operably coupled with the rotating device, the resilient assembly comprising a spring device and an extension member operably coupled with the spring device, the extension member configured to move between a first position and a second position; and
a locking component configured to be operably coupled with the rotating device and the resilient assembly, the locking component configured to move between an unlocked state and a first locked state or between the unlocked state and a second locked state, wherein the locking component is configured to be engaged with at least one of the one or more engagement features of the housing while the locking component is in the first locked state or the second locked state,
wherein one of:
the locking component is configured to move between the unlocked state and the first locked state based on a rotational speed of the rotating device, or
the locking component is configured to move between the unlocked state and the second locked state based on the extension member of the resilient assembly moving between the first position and the second position responsive to the resilient assembly receiving one or more control signals, wherein the extension member moving between the first position and the second position moves the locking component between the unlocked state and the second locked state.

Clause 2: the fall protection system of clause 1, wherein the locking component is configured to move from the unlocked state to the first locked state or from the unlocked state to the second locked state responsive to a first to occur between the rotational speed of the rotating device exceeding a designated threshold or the resilient assembly receiving the one or more control signals.

Clause 3: the fall protection system of clauses 1-2, wherein the locking component is configured to move from the first locked state or the second locked state to the unlocked state responsive to one of the rotational speed of the rotating device being less than a designated threshold or the extension component moving from the second position to the first position.

Clause 4: the fall protection system of clauses 1-3, wherein the locking component in the first locked state or the second locked state is configured to prohibit rotation of the rotating device within the housing.

Clause 5: the fall protection system of clauses 1-4, wherein the locking component includes a locking surface configured to be in contact with one or more surfaces of the at least one of the one or more engagement features of the housing while the locking component is in the first locked state or the second locked state.

Clause 6: the fall protection system of clauses 1-5, further comprising a retractable lanyard configured to be operably coupled with the rotating device, wherein the locking component is configured to control a distance of travel of the retractable lanyard.

Clause 7: the fall protection system of clause 6, wherein the retractable lanyard is configured to extend between the rotating device and a harness system operably coupled with an object, wherein the resilient assembly is configured to receive the one or more control signals from one or more processors of the harness system responsive to an amount of movement of the object operably coupled with the harness system exceeding a movement threshold.

Clause 8: the fall protection system of clause 7, wherein the resilient assembly is configured to be electrically coupled with the one or more processors of the harness system via one or more of a wireless connection or a wired connection.

Clause 9: the fall protection system of clause 7, wherein the resilient assembly is configured to receive a first control signal of the one or more control signals from the one or more processors of the harness system or a second control signal of the one or more control signals from the one or more processors of the harness system, wherein the extension member is configured to move from the first position to the second position responsive to the resilient assembly receiving the first control signal, and the extension member is configured to move from the second position to the first position responsive to the resilient assembly receiving the second control signal.

Clause 10: the fall protection system of clauses 1-9, wherein the housing includes an anchoring component configured to connect the housing to a portion of a lift system, wherein the lift system is configured to move between plural different elevated positions.

Clause 11: a method, comprising:
moving a locking component of a fall protection system between an unlocked state and one of a first locked state or a second locked state based on one of:
a rotational speed of a rotating device disposed within a housing of the fall protection system, the housing including one or more surfaces defining a cavity, the rotating device configured to be disposed within the cavity and rotate about an axis of the housing, the housing including one or more engagement features, the fall protection system including a resilient assembly configured to be operably coupled with the rotating device, the locking component configured to be operably coupled with the rotating device and the resilient assembly; or
an extension member of the resilient assembly moving between a first position and a second position responsive to the resilient assembly receiving one or more control signals, wherein the extension member moving between the first position and the second position moves the locking component between the unlocked state and the second locked state.

Clause 12: the method of clause 11, further comprising moving the locking component from the unlocked state to the first locked state responsive to the rotational speed of the rotating device exceeding a designated threshold.

Clause 13: the method of clauses 11-12, further comprising moving the locking component from the first locked state or the second locked state to the unlocked state responsive to one of the rotational speed of the rotating device being less than a designated threshold or the extension component moving from the second position to the first position.

Clause 14: the method of clauses 11-13, further comprising prohibiting rotation of the rotating device with the locking component while the locking component is in the first locked state or the second locked state.

Clause 15: the method of clauses 11-14, further comprising controlling a distance of travel of a retractable lanyard with the locking component, the retractable lanyard configured to extend between the rotating device and a harness system operably coupled with an object.

Clause 16: the method of clause 15, further comprising receiving the one or more control signals from one or more processors of the harness system responsive to an amount of movement of the object operably coupled with the harness system exceeding a movement threshold.

Clause 17: the method of clause 16, further comprising:
one or more of receiving a first control signal of the one or more control signals from the one or more processors of the harness system or receiving a second control signal of the one or more control signals from the one or more processors of the harness system; and
moving extension member of the resilient assembly from the first position to the second position responsive to the resilient assembly receiving the first control signal, or moving the extension member from the second position to the first position responsive to the resilient assembly receiving the second control signal.

Clause 18: a fall protection system, comprising:
a housing comprising one or more surfaces defining a cavity, the housing including one or more engagement features;
a rotating device configured to be disposed within the housing and rotate about an axis of the housing;
a solenoid assembly configured to be operably coupled with the rotating device, the solenoid assembly including a spring device and an extension member operably coupled with the spring device, the extension member configured to move between a retracted position and an extended position responsive to a change in an electric current within the solenoid assembly; and
a locking component configured to be operably coupled with the rotating device and the solenoid assembly, the locking component configured to move between an unlocked state and a first locked state or between the unlocked state and a second locked state,
wherein one of:
the locking component is configured to move from the unlocked state to the first locked state responsive to a rotational speed of the rotating device exceeding a designated threshold, or
the locking component is configured to move from the unlocked state to the second locked state responsive to the extension member moving from the retracted position to the extended position.

Clause 19: the fall protection system of clause 18, further comprising a retractable lanyard configured to be operably coupled with the rotating device and extend between the rotating device and a harness system operably coupled with an object, wherein the solenoid assembly is configured to receive one or more control signals from one or more processors of the harness system responsive to an amount of movement of the object exceeding a movement threshold.

Clause 20: the fall protection system of clauses 19, wherein the electric current within the solenoid assembly is configured to change responsive to the solenoid assembly receiving the one or more control signals from the one or more processors of the harness system.

As described herein, examples of the present disclosure provide systems and methods for controlling operation of a fall protection system based on either of mechanical forces acting on the fall protection system or electrical inputs received by the fall protection system, whichever is the first to occur. For example, if a rotational speed of a rotating device exceeds a designated threshold before a resilient assembly receives a control signal, the fall protection system may move from an unlocked state to a first locked state based on mechanical forces acting on the locking component. Alternatively, if the resilient assembly receives the control signal before the rotational speed of the rotating device exceeds the designated threshold, the locking component may move from the unlocked state to a second locked state based on electrical inputs received by the resilient assembly. The systems and methods described herein may move from an unlocked state to a locked state in an amount of time that is faster (e.g., a shorter amount of time) than an amount of time it may take for a single safety system (e.g., a fall safety system that relies only on mechanical forces acting on the fall safety system to move from the unlocked state to the locked state).

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A fall protection system, comprising:
a housing comprising one or more surfaces defining a cavity, the housing including one or more engagement features extending into the one or more surfaces;
a rotating device configured to be disposed within the cavity of the housing and configured to rotate about an axis of the housing;
a resilient assembly configured to be operably coupled with the rotating device, the resilient assembly comprising a spring device and an extension member operably coupled with the spring device, the extension member configured to move between a first position and a second position; and
a locking component configured to be operably coupled with the rotating device and the resilient assembly, the locking component configured to move between an unlocked state and a first locked state or between the unlocked state and a second locked state, wherein the locking component is configured to be engaged with at least one of the one or more engagement features of the housing while the locking component is in the first locked state or the second locked state,
wherein one of:
the locking component is configured to move between the unlocked state and the first locked state based on a rotational speed of the rotating device, or
the locking component is configured to move between the unlocked state and the second locked state based on the extension member of the resilient assembly moving between the first position and the second position responsive to the resilient assembly receiving one or more control signals, wherein the extension member moving between the first position and the second position moves the locking component between the unlocked state and the second locked state.

2. The fall protection system of claim 1, wherein the locking component is configured to move from the unlocked state to the first locked state or from the unlocked state to the second locked state responsive to a first to occur between the rotational speed of the rotating device exceeding a designated threshold or the resilient assembly receiving the one or more control signals.

3. The fall protection system of claim 1, wherein the locking component is configured to move from the first locked state or the second locked state to the unlocked state responsive to one of the rotational speed of the rotating device being less than a designated threshold or the extension component moving from the second position to the first position.

4. The fall protection system of claim 1, wherein the locking component in the first locked state or the second locked state is configured to prohibit rotation of the rotating device within the housing.

5. The fall protection system of claim 1, wherein the locking component includes a locking surface configured to be in contact with one or more surfaces of the at least one of the one or more engagement features of the housing while the locking component is in the first locked state or the second locked state.

6. The fall protection system of claim 1, further comprising a retractable lanyard configured to be operably coupled with the rotating device, wherein the locking component is configured to control a distance of travel of the retractable lanyard.

7. The fall protection system of claim 6, wherein the retractable lanyard is configured to extend between the rotating device and a harness system operably coupled with an object, wherein the resilient assembly is configured to receive the one or more control signals from one or more processors of the harness system responsive to an amount of movement of the object operably coupled with the harness system exceeding a movement threshold.

8. The fall protection system of claim 7, wherein the resilient assembly is configured to be electrically coupled with the one or more processors of the harness system via one or more of a wireless connection or a wired connection.

9. The fall protection system of claim 7, wherein the resilient assembly is configured to receive a first control signal of the one or more control signals from the one or more processors of the harness system or a second control signal of the one or more control signals from the one or more processors of the harness system, wherein the extension member of the resilient assembly is configured to move from the first position to the second position responsive to the resilient assembly receiving the first control signal, and the extension member is configured to move from the second position to the first position responsive to the resilient assembly receiving the second control signal.

10. The fall protection system of claim 1, wherein the housing includes an anchoring component configured to connect the housing to a portion of a lift system, wherein the lift system is configured to move between plural different elevated positions.

11. A method, comprising:
moving a locking component of a fall protection system between an unlocked state and one of a first locked state or a second locked state based on one of:
a rotational speed of a rotating device disposed within a housing of the fall protection system, the housing including one or more surfaces defining a cavity, the rotating device configured to be disposed within the cavity and rotate about an axis of the housing, the housing including one or more engagement features, the fall protection system including a resilient assembly configured to be operably coupled with the rotating device, the locking component configured to be operably coupled with the rotating device and the resilient assembly, or
an extension member of the resilient assembly moving between a first position and a second position responsive to the resilient assembly receiving one or more control signals, wherein the extension member moving between the first position and the second position moves the locking component between the unlocked state and the second locked state.

12. The method of claim 11, further comprising moving the locking component from the unlocked state to the first locked state responsive to the rotational speed of the rotating device exceeding a designated threshold.

13. The method of claim 11, further comprising moving the locking component from the first locked state or the second locked state to the unlocked state responsive to one of the rotational speed of the rotating device being less than a designated threshold or the extension member moving from the second position to the first position.

14. The method of claim 11, further comprising prohibiting rotation of the rotating device with the locking component while the locking component is in the first locked state or the second locked state.

15. The method of claim 11, further comprising controlling a distance of travel of a retractable lanyard with the locking component, the retractable lanyard configured to extend between the rotating device and a harness system operably coupled with an object.

16. The method of claim 15, further comprising receiving the one or more control signals from one or more processors of the harness system responsive to an amount of movement of the object operably coupled with the harness system exceeding a movement threshold.

17. The method of claim 16, further comprising:
one or more of receiving a first control signal of the one or more control signals from the one or more processors of the harness system or receiving a second control signal of the one or more control signals from the one or more processors of the harness system; and
moving the extension member of the resilient assembly from the first position to the second position responsive to the resilient assembly receiving the first control signal, or moving the extension member from the second position to the first position responsive to the resilient assembly receiving the second control signal.

18. A fall protection system, comprising:
a housing comprising one or more surfaces defining a cavity, the housing including one or more engagement features;
a rotating device configured to be disposed within the housing and rotate about an axis of the housing;
a solenoid assembly configured to be operably coupled with the rotating device, the solenoid assembly including a spring device and an extension member operably coupled with the spring device, the extension member configured to move between a retracted position and an extended position responsive to a change an electric current within the solenoid assembly; and
a locking component configured to be operably coupled with the rotating device and the solenoid assembly, the locking component configured to move between an unlocked state and a first locked state or between the unlocked state and a second locked state,
wherein one of:
the locking component is configured to move from the unlocked state to the first locked state responsive to a rotational speed of the rotating device exceeding a designated threshold, or
the locking component is configured to move from the unlocked state to the second locked state responsive to the extension member moving from the retracted position to the extended position.

19. The fall protection system of claim 18, further comprising a retractable lanyard configured to be operably coupled with the rotating device and extend between the rotating device and a harness system operably coupled with an object, wherein the solenoid assembly is configured to receive one or more control signals from one or more processors of the harness system responsive to an amount of movement of the object exceeding a movement threshold.

20. The fall protection system of claim 19, wherein the electric current within the solenoid assembly is configured to change responsive to the solenoid assembly receiving the one or more control signals from the one or more processors of the harness system.
